(19) United States
(12) Patent Application Publication
(10) Pub. No.: US 2024/0025152 A1
(43) Pub. Date: Jan. 25, 2024

(54) Composite Film

(71) Applicant: Constantia Teich GmbH, Weinburg (AT)

(72) Inventors: Alfred Wegenberger, Langenlois (AT); Matthias Steiner, Weinburg (AT); Roland Feichtinger, Ober-Grafendorf (AT); Patrick Relota, St. Pölten (AT)

(21) Appl. No.: 17/754,847

(22) PCT Filed: Oct. 16, 2020
(86) PCT No.: PCT/EP20/79159

§ 371 Date: Apr. 13, 2022

(30) Foreign Application Priority Data
Oct. 17, 2019 (EP) 19203777.8

(51) Int. Cl. B32B 15/085; B32B 15/082; B32B 27/32; B32B 27/30; B32B 27/20; B32B 27/08; B32B 15/20; B32B 7/12

(52) U.S. Cl. CPC B32B 15/085; B32B 15/082; B32B 27/32; B32B 27/308; B32B 27/20; B32B 27/08; B32B 15/20; B32B 7/12; B32B 2250/04; B32B 2307/72; B65D 77/2032

(57) ABSTRACT

A composite film for producing lids, including an aluminum layer and an extrusion layer, which is extruded onto the aluminum layer in multiple layers by coextrusion. The extrusion layer has a sealing layer and an adhesion promoter layer, which is arranged between the sealing layer and the aluminum layer. The sealing layer includes a polymer matrix, which has at least a first polymer constituent and a second polymer constituent. A peel-force additive, in particular a mineral filler, such as talcum, is added to the polymer matrix. The first polymer constituent is selected from a polyolefin, and the second polymer constituent is selected from polyolefin plastomers and/or polyolefin elastomers each having a density of less than 900 kg/m³, and from combinations of such materials.

### TECHNICAL FIELD

The present disclosure relates to a composite film, a lid, and a method for producing a composite film.

### BACKGROUND

In order to close packaging containers, in particular in the food and pet food sectors, so-called lids are used, which are sealed onto the edge of a packaging container in order to close it. Examples of such packaging containers include yoghurt cups, trays, or similar containers.

As a result of good processability, advantageous barrier properties and recyclability in particular, lids are often made from aluminum foils, which are optionally printed, lacquered and/or embossed and coated with a sealing material on the sealing side. Depending on the embodiment, for example laminated sealing foils, sealing lacquers, extrusion coatings or combinations of these techniques are used as the sealing material. The layers applied to the aluminum foil often serve not only to ensure sealability, but also give the lid structural properties such as improved puncture resistance, more favorable tear behavior, high burst pressure or the like.

DE 10253110 B4, for example, discloses a lid with an aluminum layer that is coated with a three-layer coextrusion coating.

Since only the aluminum portion of the sheet is easily recyclable, there is an interest in reducing the portion of materials applied as a sealing layer. However, this is opposed to by technical requirements. On the one hand, the sealing layer must be strong enough to create a sufficiently good sealing bond and on the other hand, the sealing layer should have good peeling properties, i.e. it must be possible for the consumer to peel off the lid from the packaging container without using excessive force (and without tearing the lid). It must also be taken into account that the sealing layer is suitable for the goods to be packaged, such as food. In order to improve the peeling properties, a peel-force additive, in particular a mineral filler, such as talcum, can be added to the material of the sealing layer. However, the mineral filler impairs the processability of the polymer material and causes problems during extrusion. Corresponding sealing layers with relatively high layer thicknesses must therefore be extruded.

WO 2012/113530 A1 describes a composite film consisting of an aluminum foil which is combined with a coextruded layer. The coextruded layer consists of a middle layer made of polypropylene to which a filler has been added and an adhesion promoter layer made of maleic anhydride-modified polypropylene adjoining it on both sides.

U.S. Pat. No. 5,626,929 A describes a composite film comprising an aluminum layer which is laminated with a sealing layer using a urethane adhesive. The sealing layer consists of a mixture of a butene-1/ethylene copolymer and an ethylene homopolymer, as well as an inorganic filler. The sealing layer has a thickness of 24 to 48 g/m², which means that the composite film has a high plastics content.

### SUMMARY

One of the aims of the present disclosure is to provide aluminum lids with improved recyclability, with which the proportion of plastics can be reduced, and which can be extruded onto the aluminum layer.

In a first aspect, the present disclosure relates to a composite film, in particular for producing lids, according to the features of the claims. Furthermore, the present disclosure relates to a method for producing such a composite film, in particular for producing lids. The extrusion layer can thus be produced to be particularly thin, while high line speeds can still be achieved during production. Line speeds of around 400 m/min or even higher can be run without defects or holes occurring in the melt film of the extrusion layer. This is an unexpected effect, since the addition of peel-force additives usually reduces the melt strength to such an extent that the corresponding extrusion layers either have to be made thicker or the line speed has to be reduced. Surprisingly, the addition of the second polymer constituent makes it possible to significantly reduce the thickness of the extrusion layer while maintaining the high line speed. At the same time, a good and constant seal bond strength can be achieved.

According to the present disclosure, the extrusion layer has a total thickness of 10 to 18 g/m², in particular between 10 and 15 g/m², wherein the thickness of the adhesion promoter layer is preferably between 3 and 5 g/m² and wherein the thickness of the sealing layer is preferably between 6 and 10 g/m². This very thin coating allows the ratio of polymer constituents to aluminum in the composite film to be set to a very low value, so that the composite film can fall below the limit values that define the recyclability of the composite film.

Advantageously, the proportion of the first polymer constituent in the polymer matrix is preferably between approximately 30 and approximately 70% by weight. The melt viscosity in particular can be adjusted to an advantageous value by means of the first polymer constituent.

In an advantageous embodiment, the proportion of the second polymer constituent in the polymer matrix can be between 30 and 70% by weight. By selecting the proportion of the second polymer constituent, the sealing bond strength, and the burst pressure in particular of the lid produced from the composite film can be advantageously influenced in a targeted manner.

In a further advantageous embodiment, the aluminum layer can be formed from a preferably soft or semi-hard aluminum foil with a thickness of 10 to 70 μm, in particular 20 to 38 μm. This offers very good barrier properties and allows the production of lids having the properties that customers are used to and want, such as tactile qualities, appearance, peeling properties, etc.

Optionally, the extrusion layer can have an outer top layer adjoining the sealing layer, which outer top layer preferably has a thickness of between 1 and 3 g/m². The top layer is sufficiently thin not to significantly affect the functionality of the sealing layer, at least in a negative way. If appropriate, the top layer can also impart positive properties to the surface, for example by improving the hot tack properties. In particular, the top layer offers procedural advantages in the production of the composite film, since deposits of the peel-force additive on the extrusion dies are avoided.

The second polymer constituent may preferably comprise polymer components selected from ethylene/propylene copolymer, in particular semi-crystalline ethylene-propylene copolymer, which is preferably substantially free of dienes, alpha-olefin copolymer, in particular ethylene/alpha-olefin copolymer and/or propylene/alpha-olefin copolymer, ethylene-propylene-diene elastomer, and from combinations of such substances.

The present disclosure also relates to a lid for closing a packaging container, the lid being produced from a composite film as described above, preferably by punching out or cutting out.

The present disclosure also relates to a method for producing a lid for closing a packaging container, the lid preferably being produced by punching out or cutting out from a composite film which was produced using a method described herein.

### BRIEF DESCRIPTION OF THE DRAWINGS

In the following, the present disclosure is described in greater detail with reference to FIG. 1 which, by way of example, shows a schematic and non-limiting advantageous embodiment of the present disclosure.

FIG. 1 shows a layer structure of a lid.

### DETAILED DESCRIPTION

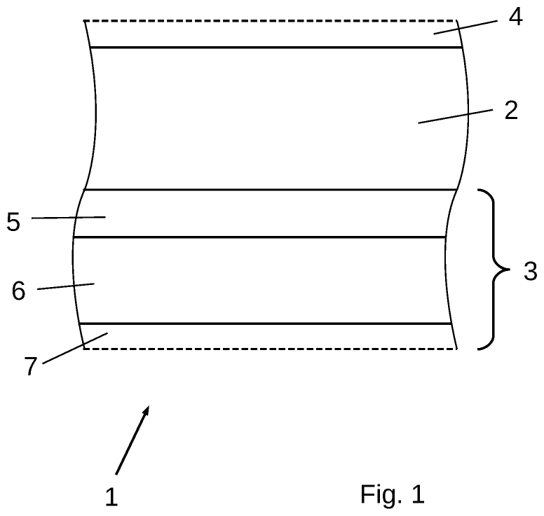

The composite film 1 shown schematically in a cross section in FIG. 1 for producing a lid substantially comprises an aluminum layer 2 which is coated with a multi-layer extrusion layer 3 on its side facing the product. Optionally, a primer layer 4 for printing can be provided on the side of the aluminum layer 2 facing away from the product. The representation of FIG. 1 is purely schematic and not to scale. In particular, it therefore does not represent the actual thickness ratios.

The extrusion layer 3 is applied to the aluminum layer 2 as a coextrudate in one operation and has an adhesion promoter layer 5 and a peelable sealing layer 6. Optionally, a thin top layer 7 can also be provided over the sealing layer. The extrusion layer 3 preferably has a total thickness of between 10 and 18 g/m² and preferably between 10 and 15 g/m².

The aluminum layer 2 consists of a preferably soft or semi-hard aluminum foil and has a preferred thickness of approximately 20 to approximately 38 μm. Optionally, the thickness can also be greater or less if this is desired or necessary for the specific application. Aluminum layers with thicknesses of, for example, between 10 and 70 μm are usually used for lids. The aluminum layer 2 serves as a substrate onto which the layers of the extrusion layer 3 are applied in a coextrusion process.

The adhesion promoter layer 5 improves the adhesion between the sealing layer 6 and the aluminum layer 2, wherein numerous materials which can be used to produce the adhesion promoter layer 5 are known in the prior art. For example, the material of the adhesion promoter layer 5 can be selected from ethylene-acrylic acid copolymer (EAA), ethylene-methacrylic acid (EMAA), maleic anhydride-modified LDPE (PE-g-MAOH), terpolymer (e.g., Lotader™ from Arkema), ionomer and comparable materials that appear to be suitable in the art for this purpose, or from combinations of these materials.

The adhesion promoter layer 5 is to allow in particular good adhesion between the sealing layer 6 and the aluminum layer 2 without the need for subsequent heat treatment, for example to sufficiently activate the adhesion promoter layer 5. Such a heat treatment after coextrusion typically takes place at temperatures between 200° C. and 300° C. and could adversely affect the flatness of the composite film 1. For example, this can lead to warping of a lid produced with the composite film 1, as a result of which the processability of the lid, in particular the sealing onto a container to close the container, would suffer. Such problems can arise with an adhesion promoter grafted with maleic anhydride (for example a PP-MAOH or PP-MAOH) in the adhesion promoter layer 5. The adhesion promoters mentioned above, which can also be used in particular with polyethylene-based sealing layers 6, adhere directly to the aluminum layer 2 and do not require any heat treatment after coextrusion.

The adhesion promoter layer 5 can preferably be extruded with a layer thickness of between 3 and 5 g/m². The actually required layer thickness is usually selected according to the manufacturer's specifications. The layer thickness of the adhesion promoter layer can be selected according to the following criteria, for example. The layer thickness is selected to be as thin as possible, because with an altogether thin coating (a maximum total thickness of 18 g is preferred), a sufficiently thick sealing layer is required for sealing and also for cost reasons, because the materials mentioned above are usually more expensive than the materials used for the sealing layer. However, the adhesion promoter layer must be thick enough to ensure a consistently homogeneous layer in order to ensure sufficiently good adhesion of the extrusion coating to the aluminum foil.

The sealing layer 6 has a polymer matrix to which a peel-force additive is added in a proportion of between 10 and 35% by weight. The sealing layer 6 can preferably be extruded with a layer thickness of between 6 and 12 g/m². In order to achieve improved recyclability of the composite film, it is useful to minimize the thickness of the extrusion layer, and in particular the thickness of the sealing layer 6. The sealing layer 6 should be as thin as possible, while still ensuring the required sealing bond strength and peeling properties. A further technical limitation is the manufacturability of the extrusion layer 3, since holes and other defects can form in the extrusion layer 3 if the layer thickness is too small. Minimizing the thickness of the extrusion layer is, given knowledge of the teachings disclosed herein, within the ability of an average person skilled in the art.

The peel-force additive can in particular be a mineral filler which is preferably food-safe. The peel-force additive can preferably be selected from talcum or talc, CaCO₃, chalk, silicates (for example mica, kaolin), other mineral fillers, or from combinations of these materials. The peel-force additive can preferably have a grain size which, even with the given thin sealing layer, does not impair it or only negligibly impairs it. In particular, the grain size D98 (“top cut”) should be less than 20 μm, for example.

The polymer matrix of the sealing layer 6 has at least two different polymer constituents, which are referred to herein as the “first polymer constituent” and the “second polymer constituent”. Optionally, further polymer constituents can also be present. The designations chosen are purely for distinguishability and are not to be interpreted as restrictive.

The first polymer constituent is a polyolefin, in particular a polyethylene, preferably a low-density polyethylene (LDPE). However, other types of polyethylene are also conceivable, such as linear low-density polyethylene (LLDPE), medium density polyethylene (MDPE) or high-density polyethylene (HDPE). As a result of the molecular structure, however, LDPE is particularly suitable. The proportion of the first polymer constituent in the polymer matrix is between approximately 30 and approximately 70% by weight.

The first polymer constituent serves as the “base material” of the sealing layer 6 and not only influences the material costs, but also the basic parameters that must be taken into account for processability, such as the melt viscosity, the drawability or melt strength and the melt film stability of the polymer matrix or the sealing layer 6 during extrusion. In particular, the melt viscosity of the polymer matrix can be changed by changing the proportion of the first polymer constituent. An advantageous melt viscosity of the polymer matrix is a melt flow index (MFI value) in a range between approximately 2 and approximately 15 g/10 min.

The second polymer constituent is selected from polyolefin plastomers and/or polyolefin elastomers each having a density of less than 900 kg/m³. The proportion of the second polymer constituent in the polymer matrix is between approximately 10 and approximately 40% by weight.

In connection with the present disclosure, “polyolefin plastomers and polyolefin elastomers” refer to copolymers based on polyolefins, which have a lower density (less than 900 kg/m³) and increased elasticity compared to the corresponding homopolymers. Examples of polyolefin plastomers and/or polyolefin elastomers include, but are not limited to, ethylene/propylene copolymers, in particular copolymers containing propylene and a minor proportion of ethylene, ethylene/alpha-olefin copolymers, propylene/alpha-olefin copolymers, ethylene-propylene-diene elastomers, and combinations of such substances. Polyolefin plastomers and polyolefin elastomers combine the properties of elastomers (i.e., dimensionally stable but elastically deformable materials) with the advantages of other plastics, such as their processability.

In specialist literature, a distinction is sometimes made between polyolefin plastomers and polyolefin elastomers, with materials with a density of 885 to 900 kg/m³ generally being referred to as polyolefin plastomers, and with a particularly low density, i.e. for example at a density of less than 885 kg/m³, the term polyolefin elastomer is preferably used. However, this definition is not always used consistently. In connection with the present disclosure, the designation “polyolefin plastomers and/or polyolefin elastomers” is therefore used uniformly for all these polymers for the sake of comprehensibility. Thus, as used herein, this term includes both materials referred to in the art as polyolefin plastomers and materials referred to as polyolefin elastomers.

Polyolefin plastomers and polyolefin elastomers are generally characterized by high toughness and high puncture resistance, good compatibility with fillers and oils, and excellent miscibility with polyolefins.

In practical application, it is important that the miscibility of the first, second and, if appropriate, further polymer constituents is ensured. This can be done in particular by selecting and matching the material parameters, with the most important parameters of the second polymer constituent being discussed below by way of example.

Important parameters for assessing the processability of the polymer material are melt indices, in particular the melt-mass flow rate (MFR) and the related melt volume flow rate (MVR). In connection with the present disclosure, the terms “melt-mass flow rate” (MFR) and “melt volume flow rate” (MVR) refer to the value determined in accordance with the standard DIN EN ISO 1133 in the most current version at the priority date of this application. In the literature and in practice, the MFR is also referred to as the “melt index,” “melt flow rate”, “melt mass-flow rate” or “melt flow index” (MFI). Analogously, the MVR is also referred to in the literature and in practice as the “melt volume rate” or “melt volume index” (MVI).

Preferred values for the melt-mass flow rate at 2.16 kg and 190° C. of the second polymer constituent range between 2 g/10 min and 15 g/10 min.

A further important parameter for the selection of the second polymer constituent is the elongation at break. The values given here for the elongation at break can be determined in accordance with the standard DIN EN ISO 527 in the most current version at the priority date of this application.

Preferred values for the elongation at break of the second polymer constituent correspond to at least a multiple of the elongation at break of the first polymer constituent and are preferably more than 200%, in particular more than 1000%.

The melting temperature of the second polymer constituent is preferably lower than the melting temperature of the first polymer constituent. The melting temperature can be measured by any method, as long as the same method is used for the first and second polymer constituent (i.e., it is ensured that the values are determined in an analogous way and are therefore comparable). For example, the standard DIN EN ISO 3146 in the most current version at the priority date of this application can be used to determine the melting point.

The melting temperature values of the second polymer constituent are preferably less than 90%, in particular less than 80%, of the corresponding melting temperature of the first polymer constituent.

The polyolefin plastomers or polyolefin elastomers which can be used, for example, as the second polymer constituent or as a component of the second polymer constituent include, for example, those commercially available under the names “Vistamaxx™,” sold by Exxon Mobil Chemical, “Versify™” and “Aplyfy™” sold by The Dow Chemical Company, “Queo™” sold by Borealis AG, “ESPRENE SPO™” sold by Sumitomo Chemical or “Tafmer™” sold by Mitsui Elastomers Singapore PTE LTD. Optionally, combinations or mixtures of these materials, optionally with other polyolefin plastomers and/or other types of polyolefin elastomers, can also be used as the second polymer constituent. The polyolefin plastomers and polyolefin elastomers that can be used in accordance with the present disclosure are also not limited to those currently commercially available, but include any polyolefin plastomers and polyolefin elastomers known in the art, or which can be prepared from materials known in the art by parameter changes within the ability of an average person skilled in the art.

Polyolefin plastomers or polyolefin elastomers, which can be used, for example, as the second polymer constituent or as a proportion of the second polymer constituent, are also disclosed, for example, in the following patent documents:

WO 2007/115816 A1 discloses propylene-based polyolefin elastomers, which are referred to in this document as “propylene-based elastomers.” These have up to 95% by weight of a first semi-crystalline polymer component in the form of a copolymer of propylene and a limited proportion of ethylene.

US 2004/0236042 A1 discloses a process for producing polyolefin elastomers, in particular thermoplastic polymer compositions with a predominant proportion of propylene and a lower proportion of ethylene.

U.S. Pat. No. 7,557,172 B2 discloses an ethylene-based polyolefin plastomer which is an ethylene/alpha-olefin copolymer.

The contents of US 2004/0236042 A1, U.S. Pat. No. 7,557,172 B2 and WO 2007/115816 A1 are made part of the content of the present description or application for the jurisdictions in which this is possible.

Although a higher proportion of the second polymer constituent can make processing during extrusion more difficult or more complex, the sealing bond strength of the sealing layer 6 is improved, in particular if said sealing layer is made very thin. In addition to the sealing bond strength, the burst pressure can also be positively influenced by changing the proportion of the second polymer constituent.

In selecting the material for the second polymeric constituent, it is important to remember that the lower the density, the more the second polymeric constituent behaves like an elastomer (i.e., rubbery). However, the melting point also falls and the stickiness increases (due to the softening of the material at elevated temperatures). This can lead to processing problems during extrusion (e.g., sticking to the chill roll) or the finished material (e.g., blocking in the roll, runnability of the material web). With knowledge of the teachings disclosed herein, an average person skilled in the art is able to sensibly select suitable combinations of materials through routine work and tests, taking into account the stated constraints.

Other polymer constituents can optionally be added to the polymer matrix of the sealing layer 6 in a proportion of up to 25% by weight.

The other polymer constituents can be selected in particular from LLDPE (C₄, C₆, C₈), mLLDPE (C₄, C₆, C₈), polypropylene homopolymer, polypropylene copolymer, or from combinations of such materials.

The other polymer constituents can serve to influence the sealing properties, for example. These can be matched to special cup materials, for example, such as cups with different proportions of polypropylene and/or polyethylene. Furthermore, for hot filling (where improved hot tack properties are required), it can be advantageous to increase the melting point of the sealing material, for example by using a C₆ polymer as an additional polymer constituent, since this has a higher melting point than, for example, the LDPE of the first polymer constituent.

The top layer 7, if provided, can preferably be extruded with a layer thickness of 1 to 3 g/m². The material of the top layer 7 is preferably selected from LDPE, LLDPE, MDPE, or from combinations of these materials.

The top layer 7 is very thin and therefore affects the sealing properties of the sealing layer 6 only insignificantly, at least in negative terms. The provision of the top layer 7 is particularly advantageous in terms of process technology. For example, the top layer separates the walls of the extrusion dies from the material of the sealing layer 6. This avoids deposits of the mineral filler, in particular talcum deposits on the extrusion dies.

In the description and claims, the terms “substantially” or “approximately,” unless otherwise stated then and there, mean a deviation of up to 10% of the stated value, if physically possible, both downwards and upwards, otherwise only in the direction that makes sense, degree indications (angle and temperature) to be understood as ±10°.

All quantities and proportions, in particular those to delimit the present disclosure, unless they relate to the specific examples, are to be understood with a tolerance of ±10%. The indication “11%” means for example: “from 9.9% to 12.1%.” In terms such as: “a solvent,” the word “a” is not to be seen as a numerical word, but as an indefinite article or as a pronoun, if nothing else emerges from the context.

The term: “combination” or “combinations,” unless otherwise indicated, means all types of combinations, starting from two of the relevant constituents up to a plurality or all of such constituents. The term: “containing” also means “consisting of.”

The individual features and variants specified in the individual configurations and examples can (unless otherwise stated then and there) be freely combined with those of the other examples and configurations and can be used in particular to characterize the present disclosure in the claims without necessarily including the other details of the relevant design or the relevant example.

1. A composite film, comprising:
an aluminum layer, and
a sealing layer, where the sealing layer includes a polymer matrix, which has at least a first polymer constituent and a second polymer constituent,
wherein a peel-force additive is added to the polymer matrix of the sealing layer,
wherein the first polymer constituent is selected from a polyolefin and the second polymer constituent is selected from polyolefin plastomers and/or polyolefin elastomers each having a density of less than 900 kg/m³, and from combinations of such materials,
wherein the composite film has an extrusion layer, which is extruded onto the aluminum layer in multiple layers by coextrusion,
wherein the extrusion layer has the sealing layer and an adhesion promoter layer, which is arranged between the sealing layer and the aluminum layer and in that the extrusion layer has a total thickness of 10 to 18 g/m²,
wherein the thickness of the adhesion promoter layer is between 3 and 5 g/m² and wherein the thickness of the sealing layer is between 6 and 10 g/m².

2. The composite film according to claim 1, wherein the proportion of the first polymer constituent in the polymer matrix is between approximately 30 and approximately 70% by weight.

3. The composite film according to claim 1, wherein the first polymer constituent is a polyolefin.

4. The composite film according to claim 1, wherein the proportion of the second polymer constituent in the polymer matrix is between 30 and 70% by weight.

5. The composite film according to claim 1, wherein the aluminum layer is formed from a soft or semi-hard aluminum foil with a thickness of 10 to 70 μm.

6. The composite film according to claim 1, wherein the extrusion layer has an outer top layer adjoining the sealing layer, which outer top layer has a thickness of between 1 and 3 g/m².

7. The composite according to claim 1, wherein the second polymer constituent has polymer components selected from ethylene/propylene copolymer, alpha-olefin copolymer, ethylene-propylene-diene elastomer, and from combinations of such substances.

8. A lid for closing a packaging container, the lid being produced from a composite film according to claim 1.

9. A method for producing a composite film, the method comprising:
providing an aluminum layer, and
extruding an extrusion layer onto the aluminum layer in multiple layers, the extrusion layer including adhesion promoter layer adjoining the aluminum layer and a sealing layer adjoining the adhesion promoter layer, wherein the extrusion layer has a total thickness of 10 to 18 g/m², wherein the thickness of the adhesion promoter layer is between 3 and 5 g/m² and wherein the thickness of the sealing layer is between 6 and 10 g/m²,
wherein the sealing layer includes a polymer matrix, which has at least a first polymer constituent and a second polymer constituent, wherein a peel-force additive is added to the polymer matrix of the sealing layer, wherein the first polymer constituent is selected from a polyolefin and the second polymer constituent is selected from polyolefin plastomers and/or polyolefin elastomers each having a density of less than 900 kg/m³, and from combinations of such materials.

10. The method according to claim 9, wherein the proportion of the first polymer constituent in the polymer matrix being between approximately 30 and approximately 70% by weight.

11. The method according to claim 9, wherein the first polymer constituent is a polyolefin.

12. The method according to claim 9, wherein the proportion of the second polymer constituent in the polymer matrix is between 30 and 70% by weight.

13. The method according to claim 9, wherein the aluminum layer is formed from a soft or semi-hard aluminum foil with a thickness of 10 to 70 μm.

14. The method according to claim 9, wherein the extrusion layer has an outer top layer adjoining the sealing layer, which outer top layer has a thickness of between 1 and 3 g/m².

15. A method for producing a lid for closing a packaging container, the lid being produced by punching out or cutting out from a composite film which was produced using a method according to claim 9.

16. The composite film according to claim 1, wherein the peel-force additive is a mineral filler.

17. The composite film according to claim 1, wherein the peel-force additive is talcum.

18. The composite film according to claim 1, wherein the extrusion layer has a total thickness of between 10 and 15 g/m².

19. The composite film according to claim 1, wherein the first polymer constituent is a low-density polyethylene.

20. The composite film according to claim 1, wherein the aluminum layer is formed from a soft or semi-hard aluminum foil with a thickness of 20 to 38 μm.
